(19) United States
(12) Patent Application Publication
(10) Pub. No.: US 2015/0356496 A1
(43) Pub. Date: Dec. 10, 2015

(54) SYSTEM AND METHOD FOR ASSIGNING EMPLOYEES TO COVERAGE AND/OR TASKS BASED ON SCHEDULE AND PREFERENCES

(71) Applicant: WAL-MART STORES, INC., Bentonville, AR (US)

(72) Inventors: Aaron Bartholomew, Bentonville, AR (US); Anthony Helms, Bentonville, AR (US); Allen Ashley, Bentonville, AR (US); Shane Le, Bentonville, AR (US); Marc Fletter, Bentonville, AR (US); Ryan Travis, Bentonville, AR (US); William Piech, Bentonville, AR (US)

(73) Assignee: WAL-MART STORES, INC., Bentonville, AR (US)

(21) Appl. No.: 14/763,111

(22) PCT Filed: Jan. 28, 2013
(86) PCT No.: PCT/US2013/023431

§ 371 Date: Jul. 23, 2015

(51) Int. Cl. G06Q 10/06

(52) U.S. Cl. CPC G06Q 10/063118

(57) ABSTRACT

A system and method for assigning employees that are schedule to work at a brick and mortar retail store location to coverage areas within the retail store and/or tasks associated with those coverage areas. The system and method takes into account the required coverage area times of each coverage area within the store location, the master schedule of employees available to work within a defined time period that is provided by a schedule management system, and management's preferences regarding coverage area priorities for or associated with certain employees, and then automatically assigns coverage to the scheduled employees based on all those variables. The system and method identifies individuals whose scheduled work shift overlaps with required coverage area times and who are preferred to work in the coverage area and assigns such individuals to work in the coverage area during the overlapping time period (or a portion thereof).

### FIELD OF THE INVENTION

The present inventive concept relates generally to employee schedule management. More specifically, the present inventive concept is concerned with a system and method for assigning employees that are schedule to work at a brick and mortar retail store location to coverage areas within the retail store and/or tasks associated with those coverage areas.

### BACKGROUND OF THE INVENTION

Many brick and mortar retailers utilize schedule management systems to help schedule appropriate staffing for a defined period of time (e.g. a 1 week, 2 week, etc. period in which the store is open or otherwise requires staffing while closed to customers). Such schedule management systems typically will take into account an employee's scheduling preferences, such as preferred work days, preferred shift time periods, vacation or other days the employee is not available to work, and days in which the employee is available to work but would prefer not to work. In addition, such schedule management systems will typically take into account the high level staffing needs of the store in calculating a master work schedule for the defined time period for the store, producing an optimized schedule based upon all criteria. While such systems provide substantial benefit and efficiencies for scheduling the proper number of employees to work any given shift within a store at the most ideal times for the store and employees, they still leave a significant amount of work that must be manually addressed by store management in assigning schedule employees to specific coverage areas within the store as well as assigning specific task that must be performed within the coverage areas.

Many retail stores will have a number of coverage areas within the store (e.g. bakery, sporting goods, electronics, etc.) that will require different levels of staffing at different times throughout the day. For example, a bakery often needs to be staffed in the early morning to prepare baked items, etc., while not as much later in the day; point of sale locations may require higher staffing mid-day, evenings and throughout the day on weekends; etc. In addition, there are often specific tasks that need to be done at specific times or within a specific time period for each coverage area. For example, it may be necessary to clean the ovens of the bakery the evening before items are to be baked; an truck scheduled to arrive in the evening may need to be unloaded by a certain time to allow the truck to proceed to its next destination; or it may be necessary to periodically check inventory levels of certain items. Certain coverage area assignments and/or tasks may require a certain employee skill set, and/or the store manager may have preferences on which employees are assigned to which coverage area and/or task. Adding to the complexity is the fact that many master schedules for multiple-location retail stores are obtained from a centrally-controlled schedule management system. Such a structure allows for the significant resources needed to perform the complex analysis and calculations of creating the master work schedule for a store to be centralized, minimizing resources required at each store. Notwithstanding, coverage area requirements and/or task requirements often vary from store to store. Thus, store management at each separate store location must take the master schedule that is output from existing schedule management systems and manually work within that master schedule to assign the scheduled employees to coverage areas. This is a very time-consuming and labor-intensive process.

Therefore, it would be beneficial to provide a system and method of assigning employees to coverage areas and/or tasks that reduces the amount of time and/or labor required, and/or automates one or more aspects of the process.

### SUMMARY OF THE INVENTION

The present invention comprises a system and method for assigning employees (e.g. associates, managers, independent contractors or other workers) that are scheduled to work at a brick and mortar retail store location to coverage areas within the retail store and/or tasks associated with those coverage areas. The system and method of the inventive concept takes into account the required coverage area times of each coverage area within the store location, the master schedule of employees available to work that is provided by a separate (or in some embodiments, related) employee schedule management system, management's preferences regarding coverage area priorities for or associated with certain employees, and then assigns coverage to the schedule employees based on all variables.

Embodiments of the system and method of the inventive concept comprise a software application that takes into account an employee's schedule, required coverage time for a coverage area, and management's preferences for what employee works which coverage areas. In one embodiment, the system takes these variables into account, and assigns the coverage to those employees who are scheduled for that coverage time with a job group that matches up to the coverage area. The system and method identifies individuals whose scheduled work shift overlaps with required coverage area times and who are preferred to work in the coverage area and assigns such individuals to work in the coverage area during the overlapping time period (or a portion thereof). For each employee and/or each coverage area, the employee's schedule (start and stop times, as well as break stop and start times), the coverage area required times (times during which a specific department at a store will require an associate be present at that department), and what coverage areas (or departments) an associate is preferred to work, are compared for overlaps. Any overlaps where an employee is scheduled for a required coverage area time on a coverage area for which they are preferred are marked for that employee as assigned to those coverage areas during those times.

The system and method of an embodiment of the inventive concept includes a coverage area assignment mechanism that accesses a master schedule database to obtain information regarding a master schedule that covers a defined time period. The master schedule includes schedule information regarding employees that are scheduled to work one or more defined shifts at a retail store within said defined time period. In one embodiment, the schedule information includes shift start and stop times for each of said employees. In another embodiment, the master schedule further includes break start and stop times (or at least windows of time in which breaks should take place).

The coverage area assignment mechanism accesses a coverage area requirements database to obtain requirements information including coverage time periods within said defined time period in which one or more coverage areas in said retail store require staffing. The coverage area assignment mechanism also accesses an employee coverage area preference database to obtain preference information including preferred coverage areas in said retail store associated with each of said employees. The coverage area assignment mechanism utilizes the accessed information to identify for each of said one or more coverage areas requiring staffing: any individuals from said employees that are associated in said coverage area preference information with the coverage area, and any overlap time periods in which at least a portion of a time period between said shift start and stop times for said any individuals overlaps with at least a portion of said coverage time periods for the coverage area. The coverage area assignment mechanism then assigns an individual to the coverage area for at least a portion of said overlap time period identified with respect to said individual; and stores in a coverage area assignment database information regarding said individual assigned to the coverage area and a time period for which said individual is assigned to the coverage area.

In some embodiments, as part of the assigning step discussed above, the coverage area assignment mechanism further assigns another individual to the coverage area for at least a portion of said overlap time period identified with respect to said another individual. In some such embodiments, said at least a portion of said overlap time period identified with respect to said another individual is not coterminous with said at least a portion of said overlap time period identified with respect to said individual. In other such embodiments, said at least a portion of said overlap time period identified with respect to said another individual is at least partially coterminous with said at least a portion of said overlap time period identified with respect to said individual.

In some embodiments, the assigning step is repeated until said coverage time periods for the coverage area are fully assigned.

In other embodiments the coverage area assignment mechanism determines any gap time periods in which said overlap time periods do not result in the coverage area being fully assigned, and assigns an individual from said employees that is not associated in said coverage area preference information with the coverage area to the coverage area for at least a portion of said gap time periods. In some such embodiments said step of assigning an individual from said employees that is not associated in said coverage area preference information with the coverage area to the coverage area for at least a portion of said gap time periods further comprises assigning another individual from said employees that is not associated in said coverage area preference information with the coverage area to the coverage area for at least a portion of said gap time periods. In some such embodiments said at least a portion of said gap time periods assigned to said another individual is not coterminous with said at least a portion of said gap time periods assigned to said individual from said employees that is not associated in said coverage area preference information with the coverage area. In other embodiments, said step of assigning an individual from said employees that is not associated in said coverage area preference information with the coverage area to the coverage area for at least a portion of said gap time periods is repeated until said coverage time periods for the coverage area are fully assigned. IN some such embodiments said coverage area assignment mechanism determines whether said coverage time periods for the coverage area are fully assigned and generating an alert notification if any gap time periods exist.

In some embodiments the coverage area assignment mechanism access a task database to obtain task information regarding tasks associated with said one or more coverage areas. In some such embodiments the coverage area assignment mechanism accesses an employee restrictions database to obtain restriction information associated with each of said employees regarding limitations on capabilities to perform specific tasks. In some embodiments said task information includes a task time period in which said task is to be completed and a task status indicator. In some such embodiments in said utilizing step said coverage area assignment mechanism utilizes said restriction information and said task information to identify any persons from said any individuals that are capable of performing tasks for which said task time period overlaps said overlap time period identified with respect to said person. In some such embodiments, said coverage area assignment mechanism uses said person as said individual assigned to the coverage area for at least a portion of said overlap time period identified with respect to said individual. In some such embodiments said coverage area assignment mechanism assigns said task to said person during said overlap time period identified with respect to said individual. In other embodiments if said person has been assigned in said assigning step a coverage area during a task time period, said coverage area assignment mechanism generates an alert that is displayed on a client device and which identifies said person as being capable of performing said task.

In some embodiments said coverage area assignment mechanism displays task information on a client device.

In some embodiments said coverage area assignment mechanism includes an assignment option input that allows a user of the client device to manually assign a task to an individual assigned to the coverage area during a task time period.

In some embodiments said assignment option input is disabled if restriction information is associated with the individual indicating that the individual is unable to perform the task.

In some embodiments said preference information includes a job group. In some embodiments, job group includes primary, secondary and salaried employees. In some such embodiments, primary and secondary employees are assigned coverage areas based on hourly shift time periods, while salaried employees are assigned to a full time period required for a coverage area. In some such embodiments identification of a job group automatically populates preference information associated with a coverage area.

In some embodiments said coverage area assignment mechanism includes an inactive employee status option input that allows a user of a client device to indicate that an employee is not available for a scheduled shift and remove said employee shift information from said schedule information utilized in said utilizing step by said coverage area assignment mechanism. In some such embodiments selection of said inactive employee status option input reinitiates said utilizing, assigning and storing steps.

In some embodiments the coverage area assignment mechanism monitors for changes in any of said master schedule, coverage areas requirements and employee coverage area preference databases and reinitiating said utilizing, assigning and storing steps in the event any changes are discovered.

In some embodiments the coverage area assignment mechanism periodically said accessing, utilizing, assigning and storing steps discussed above. In some such embodiments said repeating step is performed automatically on a predetermined time interval.

In some embodiments said requirements information is updated via a client device that accesses said coverage area requirements database. In some such embodiments updating of said requirements information automatically reinitiates said accessing, utilizing, assigning and storing steps.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is schematic diagram of a system of an embodiment of the inventive concept.

FIG. 2 is an exemplary component class diagram of an embodiment of a coverage area assignment mechanism of the inventive concept.

FIG. 3 is an exemplary sequence diagram of the embodiment of the coverage area assignment mechanism of FIG. 2.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

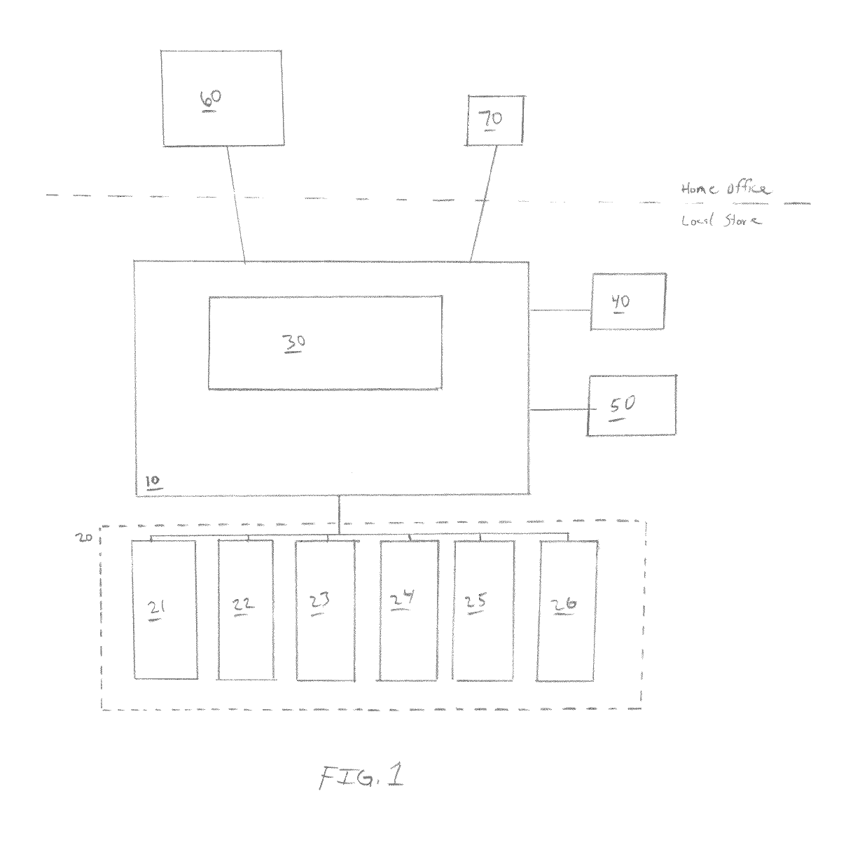

Referring to FIG. 1 a schematic block diagram of an embodiment of the instant inventive concept is shown including a network server 10 for a brick and mortar retail location, a database bank 20 accessible by the network server, a coverage area assignment mechanism 30 that (in the embodiment shown) is a computer program or subprogram of the server 10, and client terminals 40 and 50 that communicate with and/or are operably connected to server 10 and each include one or more input devices and display devices. Server 10 is also in communication with and/or operable connected to centralized schedule management system 60 and centralized updater mechanism 70. In the embodiment shown in FIG. 1, server 10 is physically located at the brick and mortar retail location in which it is utilized, while schedule management system 60 and updater mechanism 70 are both located at a central location such as a home office or headquarters for multiple brick and mortar retail locations. Nevertheless, it will be appreciated that in other embodiments, the server, schedule management system and updater mechanism will all be located in a single location such as a single store or centrally at a home office for multiple stores. Also, in other embodiments, the server will be located separately from the schedule management system and updater mechanism, but will provide dedicated functionality for performing the methods of the inventive concept that may be utilized at the individual store location.

In the embodiment shown in FIG. 1, database bank 20 is shown and described as a multiple separate databases which are accessible by server 10. Nevertheless, it will be appreciated that in other embodiments, database bank 20 will include a single database, and/or combination of several databases, that include multiple data fields. In that regard, when used herein including in the claims, the term database is intended to be inclusive of any such structure. Moreover, it will be appreciated that in some embodiments, the database bank will be part of server 10, or in some embodiments. In some embodiments in which the database bank stands alone from the server 10, the database bank will be located remotely from the server 10 and accessible via a communications network such as the internet. Furthermore, it will be appreciated that in some embodiments, the coverage area assignment mechanism 30 is a separate, stand-alone computer program from other components of the inventive system which itself will access database bank 20 and utilize and/or communicate with one or more input devices. In the embodiment shown in FIG. 1, the coverage area assignment mechanism 30 is part of a more robust network system that operates within a retail store. In some such embodiments, the coverage area assignment mechanism 30 is part of a schedule management system, while in other embodiments the coverage area assignment mechanism itself operates as the schedule management system.

In the embodiment shown in FIG. 1, server 10 is a computing platform that includes a processing entity such as a CPU that executes software and provides the core system functionality of assigning coverage areas and/or tasks to employees, and enabling the employees and managers to access and interact with information for facilitating tasks associated with the management of employee resources. In addition, server 10 may provide other functionality important to store operations such as inventory management, etc. The server 10 and its CPU are in electronic communication with all of the previously described databases, schedule management system and updater mechanism.

The software utilized by the system is encoded on a machine readable storage medium in the server 10. The software is executed by the CPU. The execution of the software in one embodiment is initiated automatically pursuant to a rules engine encoded within the software. In another embodiment, the software is initiated by an employee or other user logging into server 10.

One of the benefits of the of the instant inventive concept is that it provides local store supervisors/managers with current “real-time” information regarding the status of staffing for a plurality of coverage areas within the store as well as status of completion and assignment of tasks for such coverage areas. In addition, the inventive system allows for supervisors/managers to quickly and also automatically through then inventive system assign coverage areas and/or tasks to specific employees of the store for specific time periods in which staffing and/or completion of tasks are required. The system also allows for employees to quickly and easily determine what coverage areas they are assigned to at specific times and/or tasks they are required to complete along with any updates/modifications to such assignment information that may occur throughout a workday or other defined time period. In an exemplary embodiment, this benefit is accomplished through a wireless data server network that is electronically connected to the server/CPU and to a plurality of handheld wireless devices 40 carried by the supervisors/managers and one or more kiosks (wired or wireless) and/or handheld devices 50 available for usage by one or more employees. In some embodiments of handheld wireless devices 50 used by employees, the devices are devices owned by the store and/or directly connected to the network. In other embodiments of handheld wireless devices 50 used by employees (and/or handheld wireless devices 40 used by supervisors/managers), the devices may be devices owned personally by the employees (or supervisors/managers), such as a smart phone. In some such embodiments, the personal devices may utilize an application or other software program that supports and/or enables encrypted access to the network.

In large retail environments supervisors must be on the retail floor moving from place to place to accomplish various tasks. Many retailers issue handheld, wireless computers to their supervisors to aid them in their tasks. Such wireless computers are widely used in the art. Commercially available wireless computers such as the Motorola MC-series (MC55, MC65) are exemplary of the types of wireless, mobile computers that can be used in the practice of the invention. Through these wireless devices supervisors have direct access to the data contained in the database bank 20 and the current, real time status of coverage area assignments and tasks.

In the embodiment shown in FIG. 1, database bank 20 includes a master schedule database 21, employee coverage area preferences database 22, coverage area requirements database 23, task database 24, employee restrictions database 35 and coverage area assignment database 26, all of which are operably connected to and/or in communication with sever 10 and coverage area assignment mechanism 30.

In the embodiment of FIG. 1, a master schedule is generated by schedule management system 60 and communicated from the store home office to the local store via a communications network. The master schedule is stored locally (or for local access by sever 10) in master schedule database 21. The master schedule is generated by schedule management 60 in a conventional manner in the art utilizing employee preferences for work days, vacations schedules and general store staffing needs. The master schedule information stored in master schedule database 21 includes generally static employee information (i.e. name, job group, employee id number, etc.), as well as dynamic information such as shift start and stop times assigned to the employee during the defined time period to which the schedule relates (e.g. 1 week of store operation, 2 weeks, etc.), and break start and stop times or general time periods in which breaks should be taken during each shift. It will be appreciated that although described herein as “static”, that such employee data may be edited in database 21. The term “static” is used herein simply to refer to data/information that is typically changed on a less frequent basis than shift schedules, which are by nature dynamic.

Employee coverage area preferences database 22 includes information regarding employees that are preferred by management/supervisors of the store to be assigned to certain coverage areas. Database 22 includes a name or other identifier for each coverage area, and an identifier (such as employee name and/or id number) to associate the coverage area with specific employees in employee database 22. It will be appreciated that database 22 in some embodiments will be a field within a record for each employee in employee database 21 that includes a listing of any coverage area names in which the employee is preferred to work. In one embodiment, a manager/supervisor identifies preferred coverage areas for employees by editing information in database 22 via manager client terminal 40. The manager may identify none, one or multiple coverage areas as being preferred in association with an employee. In some embodiments, the manager may also assign a ranking or weight to the preferences, such that certain employees are selected for assignment of a coverage area by the coverage area assignment mechanism 30 before other employees. Also, the manager may assign a ranking or weight to preferences specific to multiple coverage areas for a single employee, such that a specific employee will be selected for assignment to a specific coverage area (e.g. bakery) before another coverage area (e.g. electronics).

Coverage area requirements database 23 includes coverage area name and start and stop times in which staffing is required. In addition, coverage area requirements database includes a number or quantity with respect to staffing requirements for each time period. For example, 1 employee may be required at the point of sale checkout registers between 8 am and 10 am, but 4 employees are required between 10 am and noon. The coverage area requirements database in some embodiments also includes a unique identifier associated with every individual coverage area requirement. The identifier is then utilized to associate an employee with the specific requirement in the coverage schedule database 26, described in further detail below. The manager/supervisor edits information in the coverage area requirements database via terminal 40.

Task database 24 includes information regarding tasks that are to be performed as certain times by employees working within certain coverage areas. The information includes a task name or other identifier for the task, a descriptive textual summary of the task to be performed, task performance time period (i.e. time period in which task is to be completed, can included specific start/stop times or more general start time of when task can first be initiated and stop time by which task should be completed), task visibility period (time in which task will first be visible on employee terminal 50 to an employee to which the task is assigned), task status, task start, stop and/or completion acknowledgement requirements, and employee name or identification no. for employee assigned to the task. In one embodiment the coverage area assignment mechanism identifies tasks that are scheduled to be initiated and/or completed during a specific coverage area assignment and provides a notification on the manager terminal 40 that the task needs to be completed and which employee or employees are assigned to the coverage area during the time in which the task has to be completed. In one such embodiment, the notification includes an input, such as an option selection button, that allows the manager to assign the task to an employee that has been assigned to the coverage area. In another embodiment, the coverage area assignment mechanism automatically assigns an associate to a task that is required during the time period in which the employee is assigned to the coverage area.

The employee restrictions database 25 includes information on any limitations that are associated with an employee's ability to perform certain tasks. In one embodiment, the restrictions database 25 includes an employee name and or identification number, task identifier and a Yes/No option for a list of multiple restrictions. In other embodiments, the database includes an editable field that allows a manager to enter a summary or textual listing of restrictions. It will be appreciated that in some embodiments, in addition to limitations, the restrictions database includes specific capabilities of employees. For example, limitations restrictions might include such things as “yes/no—employee can sell tobacco” or “yes/no—employee can lift over 40 lbs), while capabilities restrictions might include such things as employee is certified in CPR). In some embodiments in which a manager can manually assign a task to an employee by selecting an option button on the manager's terminal 40 in response to a task alert/notification as described above, the button will be disabled (or greyed out) with respect to any employee that has a restriction that prevents the employee from performing the task. For example, if an employee is not capable of lifting over 40 lbs, and thus includes a “no” in association with that restriction, the rules engine of the coverage area assignment mechanism will prohibit the employee from being assigned that task. Similarly, if the coverage area assignment mechanism automatically assigns tasks, the rules engine will not allow the coverage area assignment mechanism to assign a task to an employee that is restricted from that task.

Once coverage area assignments and/or task assignments are made/determined/calculated by the coverage area assignment mechanism 30, such assignments are stored in coverage schedule database 26. Database 26 includes an employee name and/or identification number, and coverage area identifiers and task identifiers that the coverage area assignment mechanism has assigned to the employee. Managers may review employee coverage and task assignments in various formats via client terminal 40. For example, managers may review coverage area reports that show coverage area requirements by coverage area and time along with employees assigned to each coverage area during the time period. In addition, such reports may include any task assignments or notifications of tasks that should be assigned. Alternatively, managers may view an employee record showing a chronological listing of coverage area and/or task assignments for each individual employee. Employees may access coverage schedule database via client terminals 50 to review their own chronological schedule of coverage area and/or task assignments. Employees may also utilize terminals 50 to acknowledge start, stop and/or completion of any tasks that require an employee's acknowledgement and track task status in the task database.

Updater mechanism 70 of the embodiment shown in FIG. 1 communicates with server 10 to provide updates to coverage area assignment mechanism 30. In addition, in some embodiments, updater mechanism 70 communicates task templates to coverage area assignment mechanism to allow local store managers to customize task requirements specific to their store. Each template defines the fields require for each task to be stored in the task database 24. In addition, task data may be reported back to task updater 70 by coverage area assignment mechanism based upon task requirements stored in task database 24. For example, the updater 70 may be utilized by the home office of the store to monitor status of task completion, and store efficiency. This can enable the home office to assist local stores, improve overall efficiencies throughout all stores and/or identify areas in which corrective action is necessary.

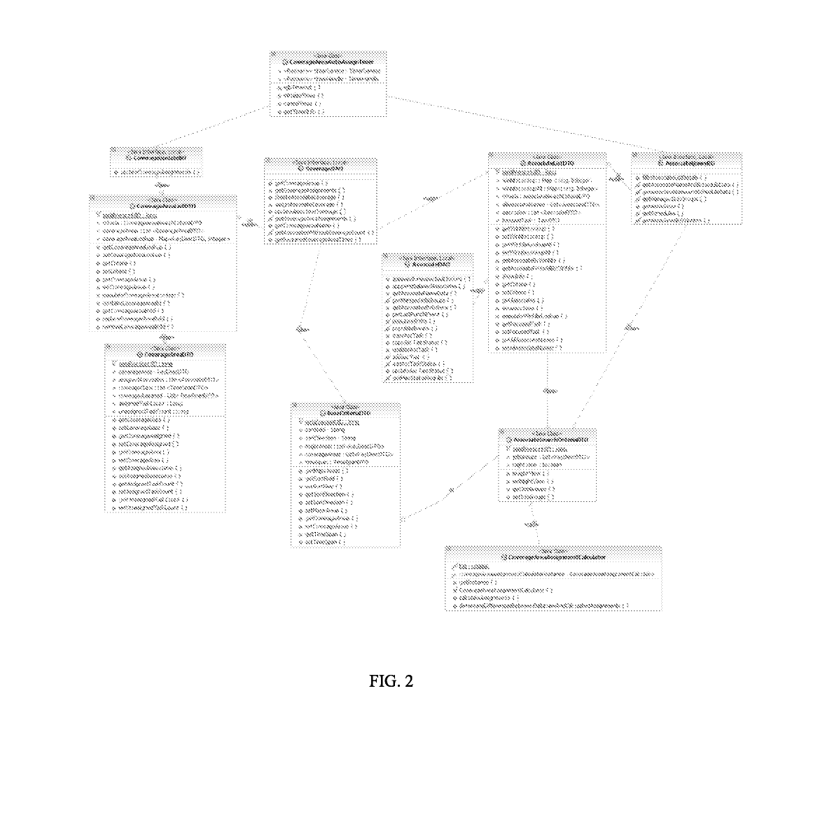

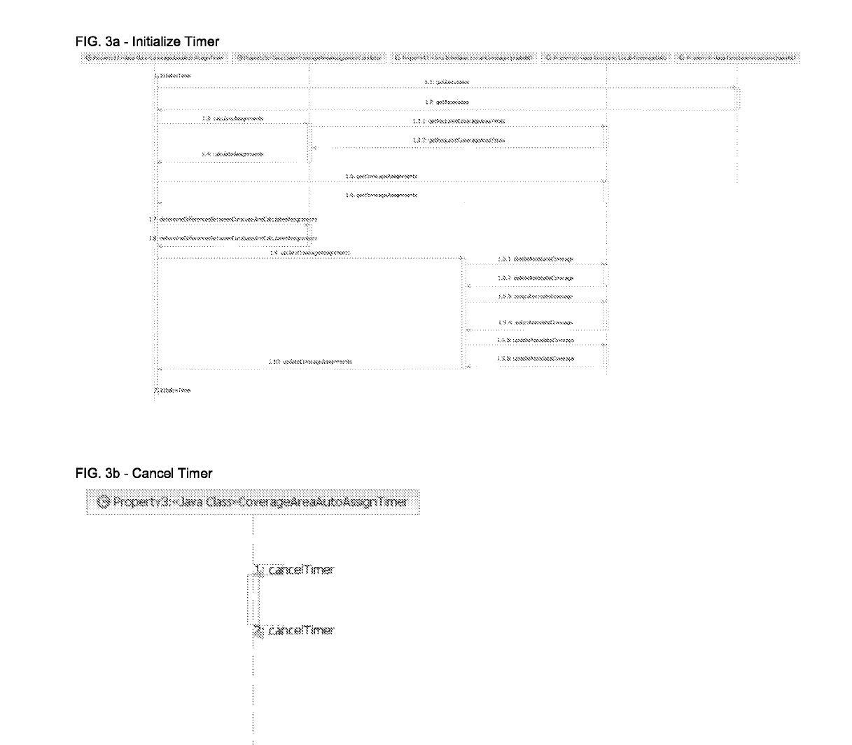

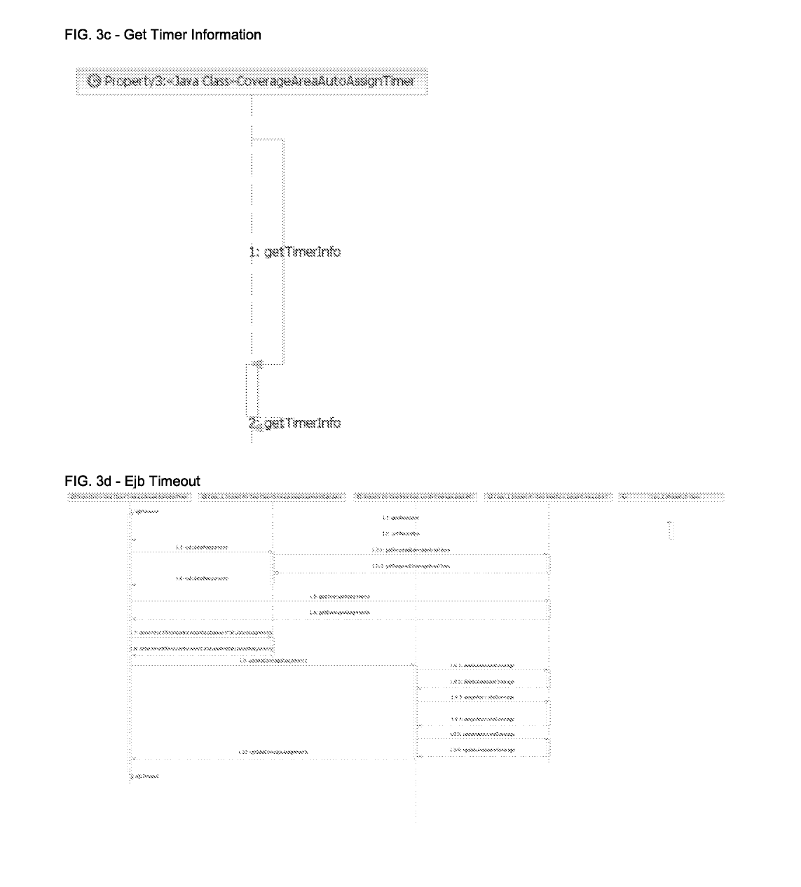

FIGS. 2 and 3 show exemplary component class and sequence diagrams, respectively, for an embodiment of the coverage area mechanism 30 of FIG. 1 in which coverage areas are automatically assigned to employees. In operation, the coverage area assignment mechanism 30 accesses master schedule database 21 to obtain the master schedule for a defined period of time that has been provided by the schedule management system 60 to obtain information on what employees are working and when during the time period. The coverage area assignment mechanism then initiates the process of calculating/determining coverage area assignments by communicating with the coverage area requirements database 23 to obtain information on what coverage areas require staffing at what times. The coverage area assignment mechanism also obtains from employee preference database 22 information regarding preferred coverage area assignments with respect to the scheduled employees. The coverage area assignment mechanism then identifies employees that are preferred for a coverage area in which an assignment is required, and identifies overlaps in the employee's shift and time period in which coverage is required. The coverage area assignment mechanism utilizes the identified overlaps to assign the employee to the coverage area for at least a portion of the overlap time period. The coverage area assignment mechanism stores the assignment information in the coverage schedule database for later access. In the embodiment shown in FIGS. 2 and 3, the coverage area assignment mechanism accesses the coverage schedule database 26 to retrieve information on assignments that have previously been made and stored and compares that information to assignments made in the assignment step discussed herein. The mechanism 30 then utilizes the comparison information to only update changes rather than completely replacing all information in database 26 every time assignment mechanism 30 performs and assignment process. Such updates are made by either deleting employee assignments that are no longer assigned and storing new employee assignments that are now being assigned.

It will be appreciated that in some embodiments, a more significant iterative process based upon a rules engine of the assignment area coverage mechanism is utilized to determine assignment of an employee for a coverage area. For example, in some embodiments, rankings or weightings are utilized with respect to employee assignment preferences.

The coverage area assignment mechanism continues assigning employees to coverage areas for overlapping time periods until the coverage area requirements are fully met. In the event all coverage area requirements are not met by employees that are preferred for the coverage area assignment, the coverage area assignment mechanism will advance the process to assign eligible employees to the coverage area that are not identified as preferred for that assignment. In the event that the coverage area assignment mechanism is unable to fully meet all coverage area requirements with such other eligible employees, the mechanism 30 will generate a notification alert via the manager terminal informing the manager that the requirement must be manually addressed.

The coverage area assignment mechanism may utilize multiple employees to met a coverage area requirement. For example, if a coverage area requirement needs an employee between 8 and 6 and shifts are from 9 to 5, 5 to 1 and 1 to 9, the assignment mechanism may utilize employees from two different shifts. Also, the assignment mechanism 30 may utilize two different employees from the same shift to achieve optimal results if necessary. In addition, the assignment mechanism 30 is capable of assigning multiple employees to the same coverage area for the same or at least partially overlapping time periods when the coverage area requirements require more than 1 employee for staffing over such period.

The coverage area assignment mechanism 30 of the embodiment shown in FIGS. 2 and 3 assigns from preferences and backend monitors all information that could affect the assignment of coverage areas, and adjusts those assignments should the data change.

In the exemplary embodiment, the data that could affect the coverage assignments is associate job group (primary, secondary, or scheduled), shift information, coverage area required coverage times, and coverage area preference modifications. In the embodiment shown, only data changes regarding coverage area required coverage times is accomplished through the coverage area assignments mechanism. In one preferred embodiment, when such changes are made, the mechanism 30 automatically initiates a process of determining or recalculating assignments. The changes in all other databases are watched for in the database, and acted upon when a change is detected. In one embodiment, the mechanism 30 periodically recalculates assignments based on current data and compares such recalculated assignments to the previously calculated and stored data.

The backend system of the exemplary embodiment of mechanism 30 exists as a singleton at application level, and maintains a current, local copy of the above-described information for each associate. On application startup, the system performs the logic necessary to compute the coverage area automatic assignments, and compares with the previous assignments in the database. If there are any differences, the database is updated.

The system is configured to run every n minutes (where n is a configurable property). When it runs, it first verifies whether any coverage area assignment affecting information has changed. If it has not, the process goes back to waiting. If assignment affecting information has been modified, then the system determines which employee assignments are affected. For each of those records, the system generates the coverage area assignments, and compare with what is in the database. Any differences in the database is corrected to the assignments computed by the system.

The coverage area assignment mechanism of FIGS. 2 and 3 includes the following objects:

Data Transfer Object:
AssociateDTO—includes associate information
AssociateListDTO—includes list of associates
AssociateSearchCriteriaDTO—includes how to search by associates
BaseCriteriaDTO—includes start/end time criteria in which to search, etc.
CoverageDTO—includes basic information of coverage assignment, time periods, etc.

Business Object:
CoverageQueryBO.getCoverageAssignments(BaseCriteriaDTO searchCriteria)—what assignments are out there
CoverageUpdateBO.updateCoverageAssignments(List<CoverageDTO> coverageList, BaseCriteriaDTO searchCriteria)—change list of assignments

Data Access Objects:
CoverageDAO.assignAssociateCoverage(CoverageDTO coverage)—make the assignment for this associate in this coverage area these times—update data
CoverageDAO.getCoverageAssignments(AssociateListDTO associateList)—for list of associates, what assignments does that associate have
CoverageDAO.deleteAssociateCoverage(CoverageDTO coverage)—remove specified assignment of associate for coverage area during time span

Utilities:
CoverageAreaAssignmentCalculator.calculateAssignments(AssociateSearchCriter iaDTO searchCriteria)
CoverageAreaAssignmentCalculator.determineDifferencesBetweenDatabaseAnd
CalculatedAssignments(List<CoverageDTO> calculatedAssignments, List<CoverageDTO> databaseAssignments)

It will be appreciated that other objects may be utilized without departing from the spirit and scope of the instant inventive concept.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method for automatically assigning employees to coverage areas within a retail store, the method comprising:
accessing by a coverage area assignment mechanism from a master schedule database a master schedule covering a defined time period, said master schedule including schedule information regarding employees each scheduled to work one or more defined shifts at a retail store within said defined time period, said schedule information including shift start and stop times for each of said employees;
accessing by said coverage area assignment mechanism from a coverage area requirements database a requirements information including coverage time periods within said defined time period in which one or more coverage areas in said retail store require staffing;
accessing by said coverage area assignment mechanism from an employee coverage area preference database a preference information including preferred coverage areas in said retail store associated with each of said employees;
utilizing by said coverage area assignment mechanism information from said accessing steps to identify for each of said one or more coverage areas requiring staffing: any individuals from said employees that are associated in said coverage area preference information with the coverage area, and any overlap time periods in which at least a portion of a time period between said shift start and stop times for said any individuals overlaps with at least a portion of said coverage time periods for the coverage area;
assigning by said coverage area assignment mechanism an individual to the coverage area for at least a portion of said overlap time period identified with respect to said individual; and
storing by said coverage area assignment mechanism in a coverage area assignment database information regarding said individual assigned to the coverage area and a time period for which said individual is assigned to the coverage area.

2. The method as claimed in claim 1, wherein said assigning an individual to the coverage area further comprises assigning another individual to the coverage area for at least a portion of said overlap time period identified with respect to said another individual.

3. The method as claimed in claim 2, wherein said at least a portion of said overlap time period identified with respect to said another individual is not coterminous with said at least a portion of said overlap time period identified with respect to said individual.

4. The method as claimed in claim 2, wherein said at least a portion of said overlap time period identified with respect to said another individual is at least partially coterminous with said at least a portion of said overlap time period identified with respect to said individual.

5. The method as claimed in claim 1, wherein said assigning an individual to the coverage area is repeated until said coverage time periods for the coverage area are fully assigned.

6. The method as claimed in claim 5, further comprising of determining by said coverage area assignment mechanism any gap time periods in which said overlap time periods do not result in the coverage area being fully assigned, and assigning an individual from said employees that is not associated in said coverage area preference information with the coverage area to the coverage area for at least a portion of said gap time periods.

7. The method as claimed in claim 6, wherein said assigning an individual from said employees that is not associated in said coverage area preference information with the coverage area to the coverage area for at least a portion of said gap time periods further comprises assigning another individual from said employees that is not associated in said coverage area preference information with the coverage area to the coverage area for at least a portion of said gap time periods.

8. The method as claimed in claim 7, wherein said at least a portion of said gap time periods assigned to said another individual is not coterminous with said at least a portion of said gap time periods assigned to said individual from said employees that is not associated in said coverage area preference information with the coverage area.

9. The method as claimed in claim 6, wherein said assigning an individual from said employees that is not associated in said coverage area preference information with the coverage area to the coverage area for at least a portion of said gap time periods is repeated until said coverage time periods for the coverage area are fully assigned.

10. The method as claimed in claim 9, further comprising the determining by said coverage area assignment mechanism whether said coverage time periods for the coverage area are fully assigned and generating an alert notification if any gap time periods exist.

11. The method as claimed in claim 1, further comprising:
accessing by said coverage area assignment mechanism from a task database task information regarding tasks associated with said one or more coverage areas.

12. The method as claimed in claim 11, further comprising:
accessing by said coverage area assignment mechanism from an employee restrictions database restriction information associated with each of said employees regarding limitations on capabilities to perform specific tasks.

13. The method as claimed in claim 11, wherein said task information includes a task time period in which said task is to be completed and a task status indicator.

14. The method as claimed in claim 13, wherein said utilizing said coverage area assignment mechanism utilizes said restriction information and said task information to identify any persons from said any individuals that are capable of performing tasks for which said task time period overlaps said overlap time period identified with respect to said person.

15. The method as claimed in claim 14, wherein said assigning said coverage area assignment mechanism uses said person as said individual assigned to the coverage area for at least a portion of said overlap time period identified with respect to said individual.

16. The method as claimed in claim 15, wherein said coverage area assignment mechanism assigns said task to said person during said overlap time period identified with respect to said individual.

17. The method as claimed in claim 14, wherein if said person has been assigned in said assigning a coverage area during a task time period, said coverage area assignment mechanism generates an alert that is displayed on a client device and which identifies said person as being capable of performing said task.

18. The method as claimed in claim 13, wherein said coverage area assignment mechanism displays task information on a client device.

19. The method as claimed in claim 13, wherein said coverage area assignment mechanism includes an assignment option input that allows a user of the client device to manually assign a task to an individual assigned to the coverage area during a task time period.

20. The method as claimed in claim 19, wherein said assignment option input is disabled if restriction information is associated with the individual indicating that the individual is unable to perform the task.

21. The method as claimed in claim 1, wherein said preference information includes a job group.

22. The method as claimed in claim 21, wherein identification of a job group automatically populates preference information associated with a coverage area.

23. The method as claimed in claim 1, wherein said coverage area assignment mechanism includes an inactive employee status option input that allows a user of a client device to indicate that an employee is not available for a scheduled shift and remove said employee shift information from said schedule information utilized in said utilizing step by said coverage area assignment mechanism.

24. The method as claimed in claim 23, wherein selection of said inactive employee status option input reinitiates said utilizing, assigning and storing steps.

25. The method as claimed in claim 1, further comprising monitoring for changes in any of said master schedule, coverage areas requirements and employee coverage area preference databases and reinitiating said utilizing, assigning and storing steps in the event any changes are discovered.

26. The method as claimed in claim 1, further comprising repeating periodically said accessing, utilizing, assigning and storing steps.

27. The method as claimed in claim 26, wherein said repeating is performed automatically on a predetermined time interval.

28. The method as claimed in claim 1, wherein said requirements information is updated via a client device that accesses said coverage area requirements database.

29. The method as claimed in claim 28, wherein updating of said requirements information automatically reinitiates said accessing, utilizing, assigning and storing steps.
